(19) United States
(12) Patent Application Publication
(10) Pub. No.: US 2023/0387428 A1
(43) Pub. Date: Nov. 30, 2023

(54) FUEL GAS SUPPLY APPARATUS FOR FUEL CELL

(71) Applicant: MITSUBISHI HEAVY INDUSTRIES, LTD., Tokyo (JP)

(72) Inventors: Yusuke Hitotsubashi, Yokohama-shi (JP); Yuichi Teramoto, Yokohama-shi (JP); Hiroki Irie, Yokohama-shi (JP)

(73) Assignee: MITSUBISHI HEAVY INDUSTRIES, LTD., Tokyo (JP)

(21) Appl. No.: 18/032,960

(22) PCT Filed: Feb. 21, 2022
(86) PCT No.: PCT/JP2022/006821

§ 371 Date: Apr. 20, 2023

(30) Foreign Application Priority Data
Feb. 26, 2021 (JP) 2021-030464

(51) Int. Cl. H01M 8/04089; H01M 8/04746; H01M 8/0438; H01M 8/12

(52) U.S. Cl. CPC H01M 8/04089; H01M 8/04753; H01M 8/0438; H01M 8/12; H01M 2008/1293

(57) ABSTRACT

A fuel gas supply apparatus for a fuel cell includes: a plurality of fuel gas supply sources, a plurality of fuel gas supply lines, a plurality of first valves disposed on the plurality of fuel gas supply lines, the first valves being capable of opening and closing on the basis of a pressure of a mixed gas of the plurality of fuel gases or a pressure of a mixed gas tank. A mixed gas supply line is provided for supplying the mixed gas containing at least one of the plurality of fuel gases to the fuel cell. The plurality of first valves open if the pressure of the mixed gas of the plurality of fuel gases or the pressure of the mixed gas tank becomes equal to or lower than a setting pressure, and the setting pressure is set to be different for each of the plurality of first valves.

### TECHNICAL FIELD

The present disclosure relates to a fuel gas supply apparatus for a fuel cell.

The present application claims priority based on Japanese Patent Application No. 2021-030464 filed on Feb. 26, 2021, with the Japanese Patent Office, the contents of which are incorporated herein by reference.

### BACKGROUND ART

A fuel cell which generates electric power through chemical reaction of a fuel gas and an oxidizing gas has excellent characteristics in terms of power generation efficiency and environmentally friendliness, for instance. In particular, a solid oxide fuel cell (SOFC) uses ceramic such as zirconia ceramic as an electrolyte, and supplies, as a fuel gas, a gas such as hydrogen, city gas, natural gas, petroleum, methanol, and a gasified gas produced from a carbon-containing material in a gasification facility, to generate electric power in a high-temperature atmosphere.

The fuel gas used for a fuel cell has a great variety as described above. Recently, it is desired to make effective use of a fuel gas whose property and supply amount are unstable compared to city gas and the like, such as a fuel gas like a biogas that is carbon neutral and hydrogen derived from renewable energy. Such a fuel gas may be used in combination with another fuel gas to realize stable operation of a fuel cell. For instance, Patent Document 1 discloses a fuel cell power generation system that uses, as a fuel gas to be supplied to the fuel cell, a mixed gas produced by mixing a hydrogen gas produced from garbage or sludge and a hydrogen gas produced by reforming a methane gas produced from waste. Furthermore, Patent Document 2 discloses a fuel cell power generation system which realizes stable power generation by complementing a gas produced from waste with a hydrogen gas derived from a hydrocarbon raw fuel as a fuel gas to be supplied to the fuel cell. Moreover, Patent Document 3 discloses, in a fuel cell system using a mixed gas containing a biogas such as a methane fermentation gas and a digestion gas as a fuel to be supplied to the fuel cell, operating the system by controlling the flow rate of the mixed gas in accordance with the change in the gas composition and the heat quantity of the biogas on the basis of the measurement result of the gas composition.

### CITATION LIST

### Patent Literature

Patent Document 1: JP2005-93087A
Patent Document 2: JP2008-204707A
Patent Document 3: JP2010-272213A

### SUMMARY

### Problems to be Solved

In a case where a fuel gas whose property or supply amount is unstable is used for a fuel cell as described above, it is necessary to control supply of the fuel gas so as not to cause shortage of the fuel component necessary for the fuel cell. In response to such necessity, Patent Document 3 discloses controlling the flow rate of the mixed gas by measuring the composition of the fuel gas to be supplied to the fuel cell. However, the measurement requires configuration like sensors and control units, which may lead to a cost increase. Particularly, if many types of fuel gases are used for the fuel cell, an extensive configuration would be required to measure respective fuel gases.

At least one embodiment of the present disclosure was made in view of the above, and an object is to provide a fuel gas supply apparatus for a fuel cell capable of effective operation using a plurality of fuel gases with a simplified configuration.

### Solution to the Problems

According to at least one embodiment of the present disclosure, to solve the above problem, a fuel gas supply apparatus for a fuel cell includes: a plurality of fuel gas supply sources capable of supplying a plurality of fuel gases respectively to the fuel cell; a plurality of fuel gas supply lines connected to the plurality of fuel gas supply sources respectively and merging with one another at a downstream side of the plurality of fuel gas supply sources; a plurality of first valves disposed on the plurality of fuel gas supply lines respectively, the first valves being capable of opening and closing on the basis of a pressure of a mixed gas of the plurality of fuel gases or a pressure of a mixed gas tank; a mixed gas supply line connecting a merging point of the plurality of the fuel gas supply lines to the fuel cell, for supplying the mixed gas containing at least one of the plurality of fuel gases to the fuel cell; and a second valve disposed on the mixed gas supply line. The plurality of first valves are configured to open if the pressure of the mixed gas of the plurality of fuel gases or the pressure of the mixed gas tank becomes equal to or lower than a setting pressure which is set in advance, and the setting pressure is set to be different for each of the plurality of first valves.

Furthermore, the fuel gas supply apparatus for the fuel cell may include a mechanism which prevents backflow of the mixed gas if the pressure of the mixed gas of the fuel gases or the pressure of the mixed gas tank becomes higher than the setting pressure set in advance, between the plurality of first valves and the merging point of the plurality of fuel gases.

### Advantageous Effects

According to at least one embodiment of the present disclosure, it is possible to provide a fuel gas supply apparatus for a fuel cell capable of efficient operation using a plurality of fuel gases with a simplified configuration.

### BRIEF DESCRIPTION OF DRAWINGS

FIG. 1 is a configuration diagram of a fuel cell according to the present embodiment.

FIG. 2 is a diagram showing an aspect of a cell stack of an SOFC cartridge depicted in FIG. 1.

FIG. 3 is a schematic configuration diagram of a fuel gas supply apparatus for a fuel cell according to an embodiment.

FIG. 4 is a flowchart of a fuel gas supply method for a fuel cell implemented by the control unit depicted in FIG. 3.

FIG. 5 is a timing chart showing an example of temporal change of the pressure of a mixed gas tank and the opening degree of the first valve during operation of the fuel cell.

### DETAILED DESCRIPTION

An embodiment of a fuel gas supply apparatus for a fuel cell according to the present invention will now be described in reference to the drawings.

Hereinafter, for the sake of convenience of description, the positional relationship of each constituent element described using expressions “top” and “bottom” with reference to the page refers to the vertically upper side and the vertically lower side, respectively. Furthermore, in the present embodiment, if the same effect can be achieved in the top-bottom direction and the horizontal direction, the top-bottom direction on the page is not necessarily limited to the vertically top-bottom direction, and may correspond to the horizontal direction orthogonal to the vertical direction.

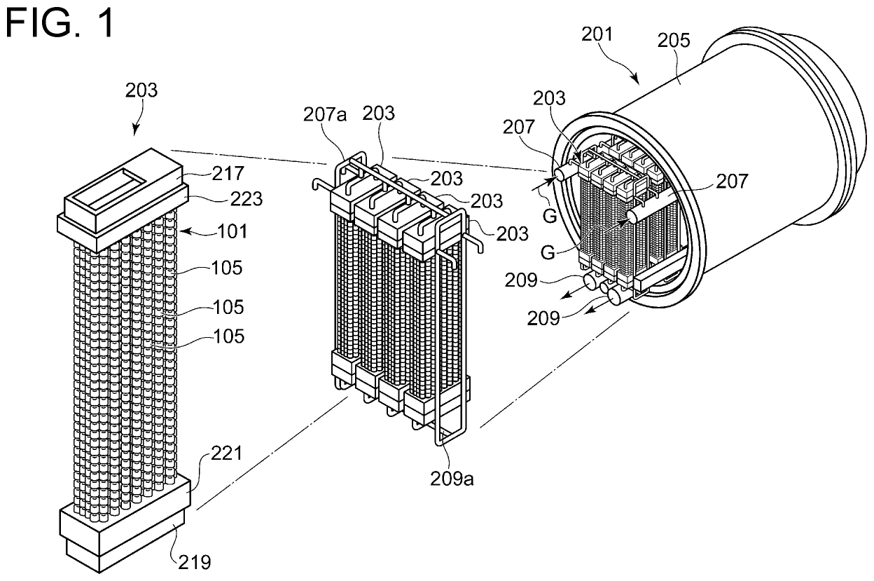

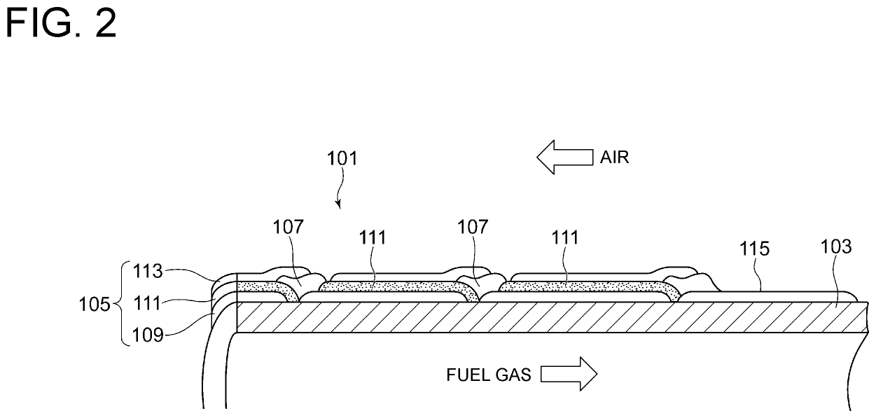

First, with reference to FIGS. 1 and 2, the configuration of a fuel cell 201 (SOFC module) according to the present embodiment will be described. FIG. 1 is a diagram showing the configuration of the fuel cell 201 according to the present embodiment, and FIG. 2 is a diagram showing an aspect of a cell stack 101 of the SOFC 203 cartridge depicted in FIG. 1. It should be noted that FIG. 1 is partially shown in cross section for better understanding of the internal configuration of the fuel cell 201.

The fuel cell 201 includes a plurality of SOFC cartridges (fuel cell cartridges) 203 and a pressure vessel 205 which accommodates the plurality of SOFC cartridges 203. An SOFC cartridge 203 includes a plurality of cell stacks 101, and each cell stack 101 includes a substrate tube 103 having a cylindrical shape, a plurality of single fuel cells 105 formed on the outer peripheral surface of the substrate tube 103, and an interconnector 107 formed between adjacent single fuel cells 105. The single fuel cell 105 is formed by laminating an anode 109, an electrolyte 111, and a cathode 113. Furthermore, the cell stack 101 includes a lead film 115 electrically connected, via the interconnector 107, to the cathode 113 of the single fuel cell 105 that is formed on one of the farthest ends of the substrate tube 103 in the axial direction, and a lead film 115 electrically connected to the anode 109 of the single fuel cell 105 that is formed on the other one of the farthest ends of the substrate tube 103 in the axial direction, from among the plurality of single fuel cells 105 formed on the outer peripheral surface of the substrate tube 103.

The substrate tube 103 is formed of a porous material, and includes CaO-stabilized ZrO₂(CSZ), a compound of CSZ and oxidized nickel (NiO) (CSZ+NiO), or Y₂O₃-stabilized ZrO₂(YSZ), or MgAl₂O₄ as main components, for instance. The substrate tube 103 supports the single fuel cell 105, the interconnector 107, and the lead film 115, and spreads a fuel gas supplied to the inner peripheral surface of the substrate tube 103 to the anode 109 formed on the outer peripheral surface of the substrate tube 103 via the fine pores of the substrate tube 103.

The anode 109 includes an oxide of a compound of Ni and a zirconia-based electrolyte material, and Ni/YSZ is used, for instance. The thickness of the anode 109 is 50 μm to 250 μm, and the anode 109 may be formed by screen printing slurry. In this case, Ni, a component of the anode 109, has catalysis with the fuel gas. The catalysis causes the fuel gas supplied via the substrate tube 103, which is a mixed gas of methane (CH₄) and water vapor for instance to react, and reform the same into hydrogen (H₂) and carbon monoxide (CO). Furthermore, the anode 109 causes hydrogen (H₂) and carbon monoxide (CO) obtained by reformulation and oxygen ions (O²⁻) supplied via the electrolyte 111 to react electrochemically in the vicinity of the interface to the electrolyte 111, thereby producing water (H₂O) and carbon dioxide (CO₂). At this time, the single fuel cell 105 generates electric power with electrons discharged from oxygen ions.

A fuel gas that can be supplied to and used for the anode 109 of a solid-oxide fuel cell includes, for instance, digestion gas, hydrogen gas derived from renewable energy, and city gas, as well as hydrogen (H₂), ammonia (NH₃), and hydrocarbon gases such as carbon monoxide (CO) and methane (CH₄), natural gas, petroleum, methanol, and a gasified gas produced from a carbon containing raw material such as coal and wood-based biomass in a gasification facility.

As the electrolyte 111, YSZ having an air tightness that hardly lets through a gas and a high oxygen-ion conductivity at a high temperature is mainly used. The electrolyte 111 transfers oxygen ions (O²⁻) produced at the cathode to the anode. The film thickness of the electrolyte 111 positioned on the surface of the anode 109 is 10 μm to 100 μm, and the electrolyte 111 may be formed by screen printing slurry.

The cathode 113 includes, for instance, a LaSrMnO₃-based oxide or a LaCoO₃-based oxide, and the cathode 113 is formed by screen printing slurry or applying slurry using a dispenser. The cathode 113 disassociates oxygen in a supplied oxidizing gas such as air and produces oxygen ions (O²⁻), in the vicinity of the interface to the electrolyte 111. The cathode 113 may have two layers. In this case, an cathode layer (cathode middle layer) closer to the electrolyte 111 is formed of a material that has a high ion conductivity and an excellent catalyst activity. The cathode layer on the cathode middle layer (cathode conductive layer) may be formed of a perovskite-type oxide expressed as Sr and Ca-doped LaMnO₃. Accordingly, it is possible to improve the power generation performance even more.

An oxidizing gas is a gas which contains approximately 15% to 30% of oxygen, and air is a suitable representative. Nevertheless, other than air, a mixed gas of combustion exhaust and air, or a mixed gas of oxygen and air can be used.

The interconnector 107 includes a conductive perovskite-type oxide expressed as M₁₋ₓLₓTiO₃ (M is an alkali earth metal element and L is a lanthanoid element) such as an SrTiO₃-based oxide, and is formed by screen printing slurry. The interconnector 107 is formed as a fine film such that the fuel gas and the oxidizing gas do not mix. Furthermore, the interconnector 107 has a high durability and a high electric conductivity under both of an oxidizing atmosphere and a reducing atmosphere. Between adjacent single fuel cells 105, the interconnector 107 electrically connects the cathode 113 of one of the single fuel cells 105 and the anode 109 of the other one of the single fuel cells 105, thereby connecting the adjacent single fuel cells 105 in series.

The lead film 115 needs to have an electric conductivity and a heat expansion coefficient close to other materials constituting the cell stack 101, and thereby consists of a compound material of Ni such as Ni/YSZ and a zirconia-based electrolyte material, or M1-xLxTiO₃ such as an SrTiO₃-based material (M is an alkali earth metal element and L is a lanthanoid element). The lead film 115 guides the direct-current electricity generated by the plurality of single fuel cells 105 connected in series via the interconnector 107 to the vicinity of an end portion of the cell stack 101.

As depicted in FIG. 1, the fuel cell 201 includes a fuel gas supply pipe 207, a plurality of fuel gas supply branch pipes 207a, a fuel gas exhaust pipe 209 and a plurality of fuel gas exhaust branch pipes 209a. Furthermore, the fuel cell 201 includes an oxidizing gas supply pipe (not depicted), a plurality of oxidizing gas supply branch pipes (not depicted), an oxidizing gas exhaust pipe (not depicted), and a plurality of oxidizing gas exhaust branch pipes (not depicted).

The fuel gas supply pipe 207 is disposed outside the pressure vessel 205, and is connected to a fuel gas supply apparatus 1 described below for suppling a fuel gas having a predetermined gas composition and a predetermined flow rate (mixed gas Gm described below) in accordance with the power generation amount of the fuel cell 201 and to the plurality of fuel gas supply branch pipes 207a. The fuel gas supply pipe 207 branches and guides the fuel gas of a predetermined flow rate (mixed gas described below) supplied from the fuel gas supply apparatus 1 into the plurality of fuel gas supply branch pipes 207a. Furthermore, the fuel gas supply branch pipes 207a are connected to the fuel gas supply pipe 207, and to the plurality of SOFC cartridges 203. The fuel gas supply branch pipes 207a guide the fuel gas (mixed gas described below) supplied from the fuel gas supply pipe 207 to the plurality of SOFC cartridges 203 in substantially equal flow rates, to substantially equalize the power generation performance of the plurality of SOFC cartridges 203.

The fuel gas exhaust branch pipes 209a are connected to the plurality of SOFC cartridges 203, and connected to the fuel gas exhaust pipe 209. The fuel gas exhaust branch pipes 209a guide exhaust fuel gas discharged from the SOFC cartridges 203 to the fuel gas exhaust pipe 209. Furthermore, the fuel gas exhaust pipe 209 is connected to the plurality of fuel gas exhaust branch pipes 209a, and partially disposed outside the pressure vessel 205. The fuel gas exhaust pipe 209 guides the exhaust fuel gas guided out from the fuel gas exhaust branch pipes 209a in substantially equal flow rates to the outside of the pressure vessel 205.

The pressure vessel 205 is operated under the internal pressure of 0.1 MPa to approximately 3 Mpa, and the internal temperature of the atmospheric temperature to approximately 550° C., and thus is formed of a material having a durability and an anti-erosion property against an oxidant such as oxygen contained in the oxidizing gas. For instance, a stainless steel material such as SUS 304 is suitable.

Herein, the present embodiment describes an aspect in which the plurality of SOFC cartridges 203 are collectively accommodated in the pressure vessel 205. Nevertheless, the present embodiment is not limited to this, and the SOFC cartridges 203 may be accommodated in the pressure vessel 205 not collectively.

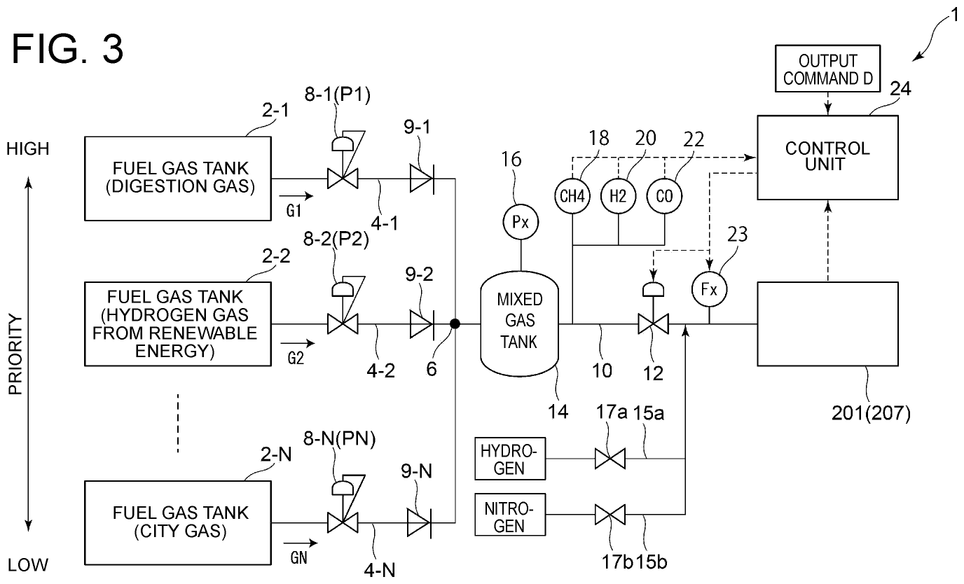

Next, the fuel gas supply apparatus 1 for supplying the fuel gas to the fuel cell 201 having the above configuration will be described. FIG. 3 is a schematic configuration diagram of the fuel gas supply apparatus 1 for the fuel cell 201 according to an embodiment. The fuel gas supply apparatus 1 is an apparatus for supplying a plurality of fuel gases to the above described fuel gas supply pipe 207.

The plurality of fuel gases include at least one fuel gas having a stable property and a sufficiently ensured supply amount. Herein, “having a stable property and a sufficiently ensured amount” means that the composition of the property is known and clarified and the variation of the composition is small, and that it is possible to constantly supply the mixed gas tank with the flow gas at a flow rate that is sufficiently greater than an amount that needs to be supplied from the mixed gas tank 14 to the fuel cell 201. In the present embodiment, city gas, which is the N-th fuel gas GN, is supplied from the fuel supply source 2-N being an infrastructure facility, and thus city gas is a stable fuel gas compared to the first fuel gas G1 (digestion gas) and the second fuel gas G2 (hydrogen gas derived from renewable energy) whose property and supply amount are not constant.

A priority is set in advance for such a plurality of gases. The priority can be set by a user arbitrarily, but a higher priority is set for a fuel gas that should be consumed prior to other fuel gases by the fuel cell being a recipient of the fuel gases. For instance, the priority for the plurality of fuel gases can be set in terms of the operation cost of the fuel cell, the preferential use of renewable energy, and the emission reduction amount of carbon dioxide. In the present embodiment, the priority is set in the following order: the first fuel gas G1, the second fuel gas G2, . . . , the N-th fuel gas GN.

A plurality of fuel gas supply lines 4-1, 4-2, . . . , 4-N, are provided to supply respective fuel gases to the fuel cell 201 from the plurality of fuel gas supply sources 2-1, 2-2, . . . , 2-N. The plurality of fuel gas supply lines 4-1, 4-2, . . . , 4-N are each connected to the fuel gas supply source at one end, and merge with one another at the other end to form a merging point 6.

A mixed gas tank 14 for storing mixed respective fuel gases (mixed gas) may be provided downstream the merging point 6.

A plurality of first valves 8-1, 8-2, . . . , 8-N are disposed on the plurality of fuel gas supply lines 4-1, 4-2, . . . , 4-N, respectively. The opening degrees of the plurality of first valves 8-1, 8-2, . . . , 8-N change on the basis of the pressure after merging of the respective fuel gases or the pressure of the mixed gas tank 14, and thereby it is possible to adjust the flow rate of each fuel gas that flows through the fuel gas supply lines 4-1, 4-2, . . . , 4-N in accordance with the priority of the fuel gases.

The plurality of first valves 8-1, 8-2, . . . , 8-N are valves whose opening degrees are adjustable in accordance with the pressure after merging of the respective fuel gases or the pressure of the mixed gas tank 14. For the plurality of first valves 8-1, 8-2, . . . , 8-N, a pressure of the secondary (downstream) side that serves as a reference for the opening-closing operation is set. The plurality of first valves 8-1, 8-2, . . . , 8-N are configured to be in an open (fuel supply) state if the pressure after merging of the respective gases or the pressure of the mixed gas tank 14 is lower than the setting pressure of the first valve, and to be in a closed state if the pressure after merging of the respective gases or the pressure of the mixed gas tank 14 is higher than the setting pressure. Specifically, setting pressures P1, P2, PN are set for the plurality of first valves 8-1, 8-2, . . . , 8-N, respectively.

The setting pressures P1, P2, PN of the plurality of first valves 8-1, 8-2, . . . , 8-N are set such that, the higher the priority set for the fuel gas, the higher the setting pressure. In the present embodiment, the priority is set in the following order: the first fuel gas G1, the second fuel gas G2, . . . , the N-th fuel gas GN. Therefore, the setting pressures are set so as to satisfy the following expression: P1>P2> . . . >PN.

It should be noted that the supply source pressure of each fuel gas is capable of supplying at a pressure higher than the setting pressures P1, P2, PN set for the respective first valves 8-1, 8-2, . . . , 8-N disposed on the respective fuel gas supply lines 4-1, 4-2, . . . , 4-N.

In the present embodiment, the plurality of first valves 8-1, 8-2, . . . , 8-N may consist of pressure-reduction valves which are mechanically controllable on the basis of the pressure after merging of the respective fuel gases or the pressure of the mixed gas tank 14. An electronic opening-degree control may be performed on the plurality of first valves 8-1, 8-2, . . . , 8-N using a controller on the basis of the detection values of pressure sensors disposed on the plurality of fuel gas supply lines 4-1, 4-2, . . . , 4-N, for instance. However, with the plurality of first valves 8-1, 8-2, . . . , 8-N being pressure reduction valves which can be mechanically controlled as described above, it is unnecessary to provide such sensors and controllers for each of the plurality of fuel gas supply lines 4-1, 4-2, . . . , 4-N, and thus it is possible to realize the fuel gas supply apparatus 1 with a more simplified configuration.

Furthermore, a mixed gas supply line 10 is disposed at the downstream side of the merging point 6 of the plurality of fuel gas supply lines 4-1, 4-2, . . . , 4-N. The plurality of fuel gases are mixed at the merging point 6 and become the mixed gas Gm, and it is possible to supply the mixed gas Gm to the fuel cell 201 via the mixed gas supply line 10 (the downstream side of the mixed gas supply line 10 is connected to the fuel gas supply pipe 207 described above). A second valve 12 for adjusting the flow rate of the mixed gas Gm is provided on the mixed gas supply line 10. Accordingly, it is possible to adjust the flow rate of the mixed gas Gm in the mixed gas supply line 10 in accordance with the opening degree of the second valve 12.

Furthermore, the mixed gas tank 14 capable of storing the mixed gas Gm is disposed on the mixed gas supply line 10. The mixed gas tank 14 is disposed on the mixed gas supply line 10 at the upstream side of the second valve 12. Accordingly, the plurality of fuel gases from the plurality of fuel gas supply lines 4-1, 4-2, . . . , 4-N are stored temporarily in the mixed gas tank 14, and thereby it is possible to reduce variation of the supply pressure even if the usage amount of the mixed gas Gm changes considerably, thereby stabilizing the operation state of the first valves 8-1, 8-2, . . . , 8-N. Furthermore, the fuel gases are mixed in advance by being stored, and thus it is possible to reduce variation of the composition of the mixed gas Gm even if the ratio of the flow rates of supply from the plurality of fuel gas supply lines 4-1, 4-2, . . . , 4-N changes, which makes it possible to stabilize operation of the fuel cell.

Furthermore, for instance, a hydrogen gas supply passage 15a and a nitrogen gas supply passage 15b for supplying a hydrogen gas and a nitrogen gas for purging the fuel system upon start or shutdown of the fuel cell 201 may be connected to the mixed gas supply line 10. In this case, the hydrogen gas supply passage 15a and the nitrogen gas supply passage 15b are connected to the mixed gas supply line 10 at the downstream side of the second valve 12. Valves 17a, 17b for adjusting the supply amounts of the hydrogen gas and the nitrogen gas are disposed on the hydrogen gas supply passage 15a and the nitrogen gas supply passage 15b.

Furthermore, the fuel gas supply apparatus 1 includes a pressure sensor 16 for detecting the pressure Px of the mixed gas Gm stored in the mixed gas tank 14, sensors for detecting the concentration of a fuel component that serves as a fuel of the fuel cell, such as a CH4 concentration sensor 18 for detecting a CH4 concentration of the mixed gas Gm, a H2 concentration sensor 20 for detecting H2 concentration of the mixed gas Gm, and a CO concentration sensor 22 for detecting the CO concentration of the mixed gas Gm, a flow-rate detector 23 for detecting the flow rate Fx of the mixed gas Gm, and a control unit 24 for controlling the opening degree of the second valve 12 on the basis of the detection values of the above sensors.

The control unit 24 is a control unit of the fuel gas supply apparatus 1, and includes, for instance, a central processing unit (CPU), a random access memory (RAM), a read only memory (ROM), and a storage medium or the like that is readable with a computer. Further, a series of processes for realizing the various functions is stored in the storage medium in the form of program, for instance. As the CPU reads the program out to the RAM or the like and executes processing and calculation of information, various functions are realized. The program may be installed in advance in the ROM or another storage medium, provided in a state stored in a storage medium that is readable by a computer, or may be distributed via wired communication or wireless communication. A storage medium that is readable by a computer refers to a magnetic disc, a magneto-optic disc, a CD-ROM, a DVD-ROM, a semiconductor memory, or the like.

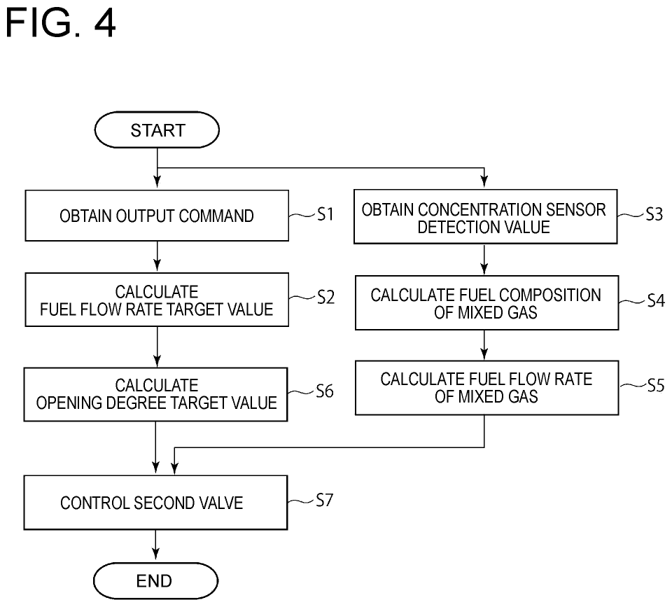

Next, the fuel gas supply method to be performed by the fuel gas supply apparatus 1 having the above configuration will be described. FIG. 4 is a flowchart of a fuel gas supply method for a fuel cell to be executed by the control unit 24 depicted in FIG. 3.

The control unit 24 obtains an output command D for the fuel cell 201 (step S1). The output command D is given in accordance with the demand and supply state of the electricity system to which electric power generated by the fuel cell 201 is to be supplied, for instance. Next, the control unit 24 calculates an output electric current target value determined by the I-V (current-voltage) of the fuel cell on the basis of the output command D obtained in step S1 (Step S2).

Meanwhile, the control unit 24 obtains the detection value of each concentration sensor of the mixed gas Gm such as the CH4 concentration sensor 18, the H2 concentration sensor 20, and the CO concentration sensor 22 (step S3), and calculates the fuel composition (H2, CO) after reforming of the mixed gas Gm on the basis of the acquisition results in step S3 (step S4). Then, the control unit 24 obtains the fuel utilization rate set in advance in accordance with the target electric current calculated in step S2 (step S5). Furthermore, the control unit 24 calculates a necessary fuel flow rate of the mixed gas Gm from the electric current target value calculated in step S2 and the fuel utilization rate obtained in step S5, on the basis of the fuel composition calculated in step S4 (step S6). Furthermore, the control unit 24 calculates the opening degree target value for the second valve 12 for achieving the flow rate (step S7). Then, the control unit 24 sends a control signal corresponding to the opening degree target value calculated in step S7 to the second valve 12, and thereby the opening degree control is performed on the second valve 12 (step S8).

As shown in FIG. 4, the flow of steps S1, 2, and 5 and the flow of steps 3 and 4 can be executed independently from one another, and the order of execution of the two flows is not particularly limited.

The control unit 24 performs the opening degree control on the second valve 12 as described above, and thereby the fuel flow rate of the mixed gas Gm is adjusted, which makes it possible to address the output command D for the fuel cell 201.

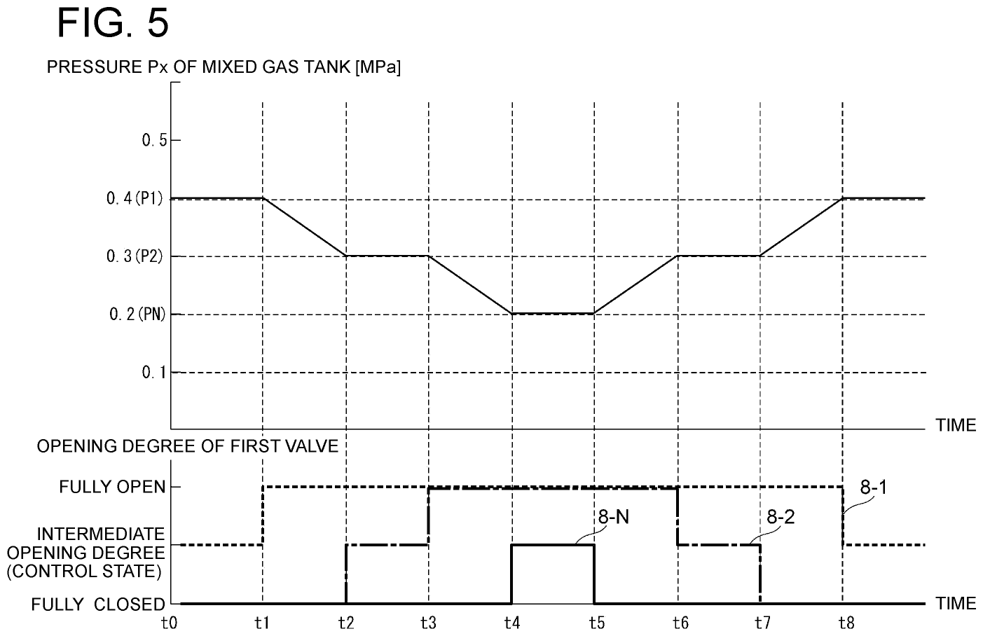

FIG. 5 is a timing chart showing an example of temporal change of the pressure of the mixed gas tank 14 and the opening degree of the first valves 8-1, 8-2, . . . , 8-N during operation of the fuel cell 201.

In the initial state indicated by time to, it is assumed that each of the plurality of fuel gas supply sources 2-1, 2-2, . . . , 2-N has a sufficient amount of fuel gas. As the fuel necessary for power generation is supplied to the fuel cell, the pressure of the mixed gas tank decreases, and firstly, only the setting pressure P1 of the first valve 8-1 becomes higher than the pressure after merging of the respective fuel gases or the pressure Px of the mixed gas tank 14, from among the first valves 8-1, 8-2, . . . , 8-N disposed on the fuel gas supply lines 4-1, 4-2, . . . , 4-N (the setting pressures of the other first valves 8-2, . . . , 8-N are lower than the pressure after merging of the respective fuel gases or the pressure of the mixed gas tank 14), and thus the first fuel gas G1 is supplied to the mixed gas tank 14 only from the first fuel gas supply line 4-1. Between time t0 and time t1, the supply of the first fuel gas G1 to the mixed gas tank 14 and the supply of the mixed gas Gm to the fuel cell 201 from the mixed gas tank 14 are balanced, and thereby the pressure Px of the mixed gas tank 14 is maintained to be substantially constant at the setting pressure P1 of the first valve 8-1.

Between time t1 and time t2, due to an increase in consumption of the fuel cell 201 by the fuel cell 201 or a decrease in the supply amount of the first fuel gas G1, the pressure after mixing of the respective fuel gases or the pressure Px of the mixed gas tank 14 gradually decreases with time even though the first valve 8-1 is fully open. Then, at time t2, when the pressure after merging of the respective fuel gases or the pressure Px of the mixed gas tank 14 reaches the setting pressure P2 of the first valve 8-2, the first valve 8-2 opens and supply of the second fuel gas G2 from the fuel gas supply source 2-2 is started. Accordingly, if the first fuel gas G1 falls short, the second fuel gas G2 having the second highest priority is supplied, and thereby the pressure after mixing of the respective fuel gases or the pressure Px of the mixed gas tank 14 is controlled to be the setting pressure P2 of the first valve 8-2.

Between time t2 and time t3, the supply of the mixed gas Gm (the first fuel gas G1+the second fuel gas G2) to the mixed gas tank 14 and the supply of the mixed gas Gm to the fuel cell 201 from the mixed gas tank 14 are balanced, and thereby the pressure after mixing of the respective fuel gases or the pressure Px of the mixed gas tank 14 is maintained to be substantially constant at the setting pressure P2 of the first valve 8-2.

Between time t3 and time t4, due to a further increase in consumption of the fuel gas by the fuel cell 201 or a decrease in the supply amount of the first fuel gas G1 or the second fuel gas G2, the pressure after merging of the respective fuel gases or the pressure Px of the mixed gas tank 14 gradually decreases with time. Then, at time t4, when the pressure after mixing of the respective fuel gases or the pressure Px of the mixed gas tank 14 reaches the setting pressure PN of the first valve 8-N, the first valve 8-N opens and supply of the N-th fuel gas GN from the fuel gas supply source 2-N is started. Accordingly, if the fuel from the plurality of fuel gas supply sources falls short, the N-th fuel gas GN having a sufficiently amount is supplied in the end, and thereby the pressure after mixing of the respective fuel gases or the pressure Px of the mixed gas tank 14 is controlled to be the setting pressure PN of the first valve 8-N.

Between time t4 and time t5, the supply of the mixed gas Gm (the first fuel gas G1+the second fuel gas G2+the N-th fuel gas GN) to the mixed gas tank 14 and the supply of the mixed gas Gm to the fuel cell 201 from the mixed gas tank 14 are balanced, and thereby the pressure after mixing of the respective fuel gases or the pressure Px of the mixed gas tank 14 is maintained to be substantially constant at the setting pressure PN of the first valve 8-N.

In contrast, between time t5 and time t6, due to a decrease in consumption of the fuel gas by the fuel cell 201 or an increase in the supply amount of the first fuel gas G1 or the second fuel gas G2, for instance, the pressure after mixing of the respective fuel gases or the pressure Px of the mixed gas tank 14 gradually increases with time. Thus, if the pressure after merging of the respective fuel gases or the pressure Px of the mixed gas tank 14 exceeds the setting pressure PN, the first valve 8-N is controlled to be closed, and thereby supply of the N-th fuel gas GN from the fuel gas supply source 2-N stops. Accordingly, it is possible to reduce consumption of the N-th fuel gas GN having a low priority, and thereby reduce the operation cost of the fuel cell 201 and the emission amount of carbon dioxide effectively.

Between time t5 and t6, the pressure Px of the mixed gas tank 14 gradually increases, and when the pressure Px reaches the setting pressure of the first valve 8-2 at time t6, the first valve 8-2 starts a pressure control from the full open state so that the pressure after mixing of the respective gases or the pressure Px of the mixed gas tank 14 becomes equal to the setting pressure P2.

Between time t6 and time t7, the supply of the mixed gas Gm (the first fuel gas G1+the second fuel gas G2) to the mixed gas tank 14 and the supply of the mixed gas Gm to the fuel cell 201 from the mixed gas tank 14 are balanced, and thereby the pressure after merging of the respective fuel gases or the pressure Px of the mixed gas tank 14 is maintained to be substantially constant at the setting pressure P2 of the first valve 8-2.

Then, at time t7, when the pressure after mixing of the respective fuel gases or the pressure Px of the mixed gas tank 14 exceeds the setting pressure P2, the first valve 8-2 is controlled to close and supply of the second fuel gas G2 from the fuel gas supply source 2-2 stops. As a result, the state returns to the initial state, where only the first fuel gas G1 having the highest priority is supplied.

In a case where the pressure of the mixed gas tank 14 changes as described above, the respective first valves 8-1, 8-2, . . . , 8-N open and close in accordance with the magnitude relationship with the respective setting pressures P1, P2, PN, thereby maximizing the opportunity to use a fuel gas with a higher priority, and fuel gases having a lower priority are used in turn in accordance with the amount of shortage, which makes it possible to ensure the necessary fuel flow rate for the fuel cell 201.

Furthermore, a backflow prevention mechanism may be disposed at the downstream side of each of the first valves 8-1, 8-2, . . . , 8-N so that the fuel gas does not flow back to the fuel gas supply sources 2-1, 2-2, . . . , 2-N if the pressure after mixing of the respective fuel gases or the pressure Px of the mixed gas tank 14 exceeds the setting pressures P1, P2, PN of the first valves 8-1, 8-2, . . . , 8-N disposed on the fuel gas supply lines 4-1, 4-2, . . . , 4-N. As a backflow prevention mechanism, a shut-off valve may be provided to shut off the fuel gas supply line when the pressure after mixing of the respective fuel gases or the pressure Px of the mixed gas tank 14 is higher than the setting pressure P1, P2, PN, or a check valve that prevents backflow mechanically may be provided. With a check valve that prevents backflow mechanically, it is possible to prevent backflow with a more simplified system.

It is possible to replace a constituent element of the above embodiment with a known constituent element without departing from the scope of the present disclosure, and the above embodiments may be combined appropriately.

The contents described in the above respective embodiments can be understood as follows, for instance.

(1) According to an aspect, a fuel gas supply apparatus for a fuel cell (e.g., of the above embodiment) includes: a plurality of fuel gas supply sources (e.g., the plurality of fuel gas supply sources 2-1, 2-2, . . . , 2-N capable of supplying the plurality of fuel gases G1, G2, . . . , GN of the embodiment) respectively to a fuel cell; a plurality of fuel gas supply lines (e.g., the fuel gas supply lines 4-1, 4-2, . . . , 4-N of the above embodiment) connected to the plurality of fuel gas supply sources respectively and merging with one another at a downstream side of the plurality of fuel gas supply sources; a plurality of first valves (e.g., the first valves 8-1, 8-2, . . . , 8-N of the above embodiment) disposed on the plurality of fuel gas supply lines respectively, the first valves being capable of opening and closing on the basis of a pressure (e.g., the pressure Px of the above embodiment) of a mixed gas of the plurality of fuel gases or a pressure of a mixed gas tank (e.g., the mixture gas tank 14 of the above embodiment); a mixed gas supply line (e.g., the mixed gas supply line 10 of the above embodiment) connecting a merging point (e.g., the merging point 6 of the above embodiment) of the plurality of the fuel gas supply lines to the fuel cell, for supplying the mixed gas (e.g., the mixed gas Gm of the above embodiment) containing at least one of the plurality of fuel gases to the fuel cell; and a second valve (e.g., the second valve 12 of the above embodiment) disposed on the mixed gas supply line. The plurality of first valves are configured to open if the pressure of the mixed gas of the plurality of fuel gases or the pressure of the mixed gas tank becomes equal to or lower than a setting pressure (e.g., the setting pressures P1, P2, . . . , PN of the above embodiment) which is set in advance, and the setting pressure is set to be different for each of the plurality of first valves.

According to the above aspect (1), it is possible to supply the mixed gas containing fuel gases supplied in accordance with the priority of supply from the plurality of fuel supply sources of the plurality of fuel gases to the fuel cell. The first valve whose opening degree is adjustable in accordance with pressure is disposed on the plurality of fuel gas supply lines, and is configured to open if the pressure of after mixing of the respective fuel gases or the pressure of the mixed gas tank becomes equal to or lower than each setting pressure. The setting pressures of the respective first valves are set to be different from one another, and thus it is possible to extract the fuel gases from the plurality of fuel supply sources in turn, and supply the fuel gases to the fuel cell as the mixed gas. Accordingly, by supplying the mixed gas containing the plurality of fuel gases to the fuel cell, it is possible to operate the fuel cell utilizing a plurality of fuel gases.

(2) In another aspect, in the above aspect (1), the plurality of fuel gases have a priority which is set in advance, and the setting value is set such that, the higher the priority, the higher the setting value.

According to the above aspect (2), the setting pressure of each first valve is set on the basis of the priority. In particular, the setting pressure is set to be larger for a fuel gas having a higher priority to increase the use frequency of a fuel gas having a high priority, and a fuel gas having a lower priority is supplied as the mixed gas if using only the fuel gas with a high priority is insufficient. Accordingly, it is possible to use the fuel gases intended by the user efficiently, while reducing the operation cost of the fuel cell 201 and the exhaust amount of carbon dioxide effectively.

(3) In another aspect, in the above aspect (1) or (2), the plurality of first valves are pressure reduction valves whose opening degrees are adjustable in accordance with the pressure of the mixed gas of the fuel gases or the pressure of the mixed gas tank.

According to the above aspect (3), the first valve disposed in each fuel gas supply line is a pressure reduction valve, and thus it is possible to realize the above apparatus with a simple configuration without using a configuration such as a sensor for detecting pressures or a controller for generating control signals on the basis of the sensor.

(4) In another aspect, in any one of the above aspects (1) to (3), the fuel gas supply apparatus further includes a mixed gas tank (e.g., the mixed gas tank 14 of the above embodiment) capable of storing the mixed gas, disposed on the mixed gas supply line at an upstream side of the second valve.

According to the above aspect (4), the plurality of fuel gases from the plurality of fuel gas supply lines are stored temporarily in the mixed gas tank, and thereby it is possible to reduce variation of the supply pressure even if the usage amount of the mixed gas changes, and stabilize the operation state of the first valves. Furthermore, the fuel gases are mixed sufficiently by being stored, and thus it is possible to reduce variation of the composition of the mixed gas even if the ratio of the supply flow rates from the plurality of fuel gas supply lines changes, which makes it possible to stabilize the operation of the fuel cell.

(5) In another aspect, in any one of the above aspects (1) to (4), the fuel gas supply apparatus further includes a unit for measuring a fuel composition of the mixed gas supplied to the fuel cell from the second valve, a unit for detecting a flow rate of the mixed gas.

According to the above aspect (5), the fuel composition of the mixed gas having a stable property is measured, and the control unit calculates the flow rate of the mixed gas to be supplied to the fuel cell on the bases of an output command based on the measurement result.

(6) In another aspect, in any one of the above aspects (1) to (5), the fuel gas supply apparatus includes a mixed gas flow rate detection unit, and a flow rate of mixed gas calculated on the basis of a fuel composition contained in the mixed gas supplied to the fuel cell is controlled through an opening degree of the second valve and the mixed gas flow rate detection unit.

According to the above aspect (6), by controlling the opening degree of the second valve on the basis of the fuel composition contained in the mixed gas, it is possible to appropriately supply the necessary flow rate of mixed gas for power generation of the fuel sell.

(7) In another aspect, in any one of the above aspects (1) to (6), the fuel gas supply apparatus further includes a backflow prevention mechanism which prevents backflow of the mixed gas to the fuel gas supply source if the pressure of the mixed gas of the fuel gases or the pressure of the mixed gas tank becomes higher than the setting pressure of the first valve disposed on corresponding one of the fuel gas supply lines.

According to the above aspect (7), by providing a backflow prevention mechanism, it is possible to prevent backflow of the mixed gas to the upstream side of the first valve even if the pressure at the downstream side of the first valve becomes higher than the setting pressure, and realize a fuel gas supply apparatus with a high reliability.

(8) In another aspect, in any one of the above aspects (1) to (7), the plurality of fuel gases include at least one fuel gas which has a stable property and a sufficiently ensured supply amount.

According to the above aspect (8), by using a fuel gas that has a stable property and a sufficient supply amount such as city gas, it is possible to make up for shortage by using a fuel gas that has a stable property and a sufficient supply amount in case of shortage, even in a case where a fuel gas that does not have a stable property or a stable supply amount such as digestion gas and hydrogen gas derived from renewable energy is used preferentially. Accordingly, it is possible to reduce the operation cost of the fuel cell by suppressing consumption of fuel gas that has a stable property and a stable supply amount, and make effective use of a fuel gas that does not have a stable property or a stable supply amount such as digestion gas and hydrogen gas derived from renewable energy.

### REFERENCE SIGNS LIST

1 Fuel gas supply apparatus
2-1, 2-2, . . . , 2-N Fuel gas supply source
4-1, 4-2, . . . , 4-N Fuel gas supply line
6 Merging point
8-1, 8-2, . . . , 8-N First valve
9-1, 9-2, . . . , 9-N Backflow prevention mechanism
10 Mixed gas supply line
12 Second valve
14 Mixed gas tank
16 Pressure sensor
18 CH4 concentration sensor
20 H2 concentration sensor
22 CO Concentration sensor
23 Mixed gas flow-rate detector
24 Control unit
101 Cell stack
103 Substrate tube
105 Single fuel cell
107 Interconnector
109 Anode
111 Electrolyte
113 Cathode
115 Lead film
201 Fuel cell
203 SOFC cartridge
205 Pressure vessel
207 Fuel gas supply pipe
207a Fuel gas supply branch pipe
209 Fuel gas exhaust pipe
209 Fuel gas exhaust branch pipe
D Output command
G1, G2, GN Fuel gas
Gm Mixed gas
P1, P2, PN Setting pressure

1. A fuel gas supply apparatus for a fuel cell, comprising:
a plurality of fuel gas supply sources capable of supplying a plurality of fuel gases respectively to the fuel cell;
a plurality of fuel gas supply lines connected to the plurality of fuel gas supply sources respectively and merging with one another at a downstream side of the plurality of fuel gas supply sources;
a plurality of first valves disposed on the plurality of fuel gas supply lines respectively, the first valves being capable of opening and closing on the basis of a pressure of a mixed gas of the plurality of fuel gases or a pressure of a mixed gas tank;
a mixed gas supply line connecting a merging point of the plurality of the fuel gas supply lines to the fuel cell, for supplying the mixed gas containing at least one of the plurality of fuel gases to the fuel cell; and
a second valve disposed on the mixed gas supply line,
wherein the plurality of first valves are configured to open if the pressure of the mixed gas of the plurality of fuel gases or the pressure of the mixed gas tank becomes equal to or lower than a setting pressure which is set in advance, and
wherein the setting pressure is set to be different for each of the plurality of first valves.

2. The fuel gas supply apparatus for a fuel cell according to claim 1,
wherein the plurality of fuel gases have a priority which is set in advance, and
wherein the setting value is set such that, the higher the priority, the higher the setting value.

3. The fuel gas supply apparatus for a fuel cell according to claim 1,
wherein the plurality of first valves are pressure reduction valves whose opening degrees are adjustable in accordance with the pressure of the mixed gas of the fuel gases or the pressure of the mixed gas tank.

4. The fuel gas supply apparatus for a fuel cell according to claim 1,
wherein the mixed gas tank is disposed on the mixed gas supply line at an upstream side of the second valve.

5. The fuel gas supply apparatus according to claim 1, further comprising:
a unit for measuring a fuel composition of the mixed gas supplied to the fuel cell from the second valve.

6. The fuel gas supply apparatus for a fuel cell according to claim 1,
wherein an opening degree of the second valve is controlled on the basis of a flow rate of necessary mixed gas calculated on the basis of a fuel composition contained in the mixed gas supplied to the fuel cell.

7. The fuel gas supply apparatus for a fuel cell according to claim 1, further comprising:
a backflow prevention mechanism which prevents backflow of the mixed gas to the fuel gas supply source if the pressure of the mixed gas of the fuel gases or the pressure of the mixed gas tank becomes higher than the setting pressure of the first valve disposed on corresponding one of the fuel gas supply lines.

8. The fuel gas supply apparatus for a fuel cell according to claim 1,
wherein the plurality of fuel gases include at least one fuel gas which has a stable property and a sufficiently ensured supply amount.
